(19) United States
(12) Patent Application Publication
(10) Pub. No.: US 2006/0248783 A1
(43) Pub. Date: Nov. 9, 2006

(54) Disposable/reusable insect trap with visual attractant

(76) Inventors: Lisa L. Lindquist, Maple Grove, MN (US); Jeffrey S. Lindquist, Maple Grove, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/430,206

(22) Filed: May 8, 2006

Related U.S. Application Data
(60) Provisional application No. 60/678,858, filed on May 6, 2005.

(51) Int. Cl. A01M 1/04; A01M 1/14

(52) U.S. Cl. 43/113; 43/114

(57) ABSTRACT

A disposable or reusable insect trap having an inner surface and an outer surface, the trap having a light source on said inner surface and an adhesive on said outer surface for adhering insects thereon.

### CROSS REFERENCE TO RELATED U.S. APPLICATION

This application is a Non-Provisional application from co-pending Provisional Application Ser. No. 60/678858 filed May 6, 2005, the contents of which are incorporated herein by reference in its entirety.

### FIELD OF THE INVENTION

The present invention relates to the field of insect traps.

### BACKGROUND OF THE INVENTION

Biting insects use chemical, visual, and thermal cues to locate hosts.

It is well known that insects of many kinds can be killed by being attracted to a sticky surface upon which they then get stuck. Fly paper is the best known example of this method of insect control.

It is also known to employ light to attract insects. See for example, U.S. Pat. No. 5,142,815, U.S. Pat. No. 5,513,465 and U.S. Pat. No. 6,871,443.

There are a variety of concerns with various methods of controlling insects such as concerns over the use of toxic chemicals, electrical power dangers, and the dangers associated with the use of propane tanks, for example.

There remains a need in the art for a safe, easy to use method of controlling insects.

### SUMMARY OF THE INVENTION

In one aspect, the present invention relates to a disposable or reusable insect trap having a visual attractant such as a source of illumination.

In one embodiment, the present invention relates to a disposable or reusable insect trap having a power source and a visual attractant in communication with the power source, and an outer surface having a coating to which insects adhere.

The power source may be battery operated.

The visual attractant may be a light in communication with the power source.

In another embodiment, the present invention relates a disposable or reusable insect trap having a visual attractant which requires no power source.

The visual attractant may be luminescence through fluorescence or phosphorescence.

In one embodiment, the insect trap is a stick or cylinder containing a glowing compound, the outer surface of the stick or cylinder having a sticky substance for trapping insects thereon. The outer surface may be further covered with a release liner.

The present invention is advantageous in that it is easy to use, portable, available in disposable or reusable forms, non-hazardous, safe and affordable.

The present invention does not employ hazardous chemicals which may be toxic to humans and animals, and is safer than using candles such as citronella candles which can be a fire hazard if not properly used.

Furthermore, no electrical power source, or propane or gas source is required, both of which have the obvious dangers associated therewith.

These and other aspects, embodiments and advantages of the present invention will become immediately apparent to those of ordinary skill in the art upon review of the Detailed Description and Claims to follow.

### BRIEF DESCRIPTION OF THE DRAWINGS

FIG. 1 is a perspective view of a tacky, elongated glow stick according to the invention.

FIG. 2 is a radial cross-section taken at section 2 in FIG. 1.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

All published documents, including all US patent documents, mentioned anywhere in this application are hereby expressly incorporated herein by reference in their entirety. Any copending patent applications, mentioned anywhere in this application are also hereby expressly incorporated herein by reference in their entirety.

The present invention relates to an insect trap and method for controlling insects. The trap includes at least one visual attractant, and at least one coating on the outer surface of the trap which is sufficiently tacky to adhere insects. In some embodiments, the trap may further include a device for hanging or suspending the trap. In some embodiments, a power source may also be included with the insect trap.

The glow of fluorescence or phosphorescence, particularly at night, attracts bugs such as mosquitoes, which can become attached to the sticky adhesive composition on the outer surface of the which is the form of a glow stick 10 formed of a polymeric material, the glow stick having an outer surface and an inner surface defining a wall, and within the wall of the glow stick 10, a compound which provides illumination such that insects are attracted to the glow stick 10.

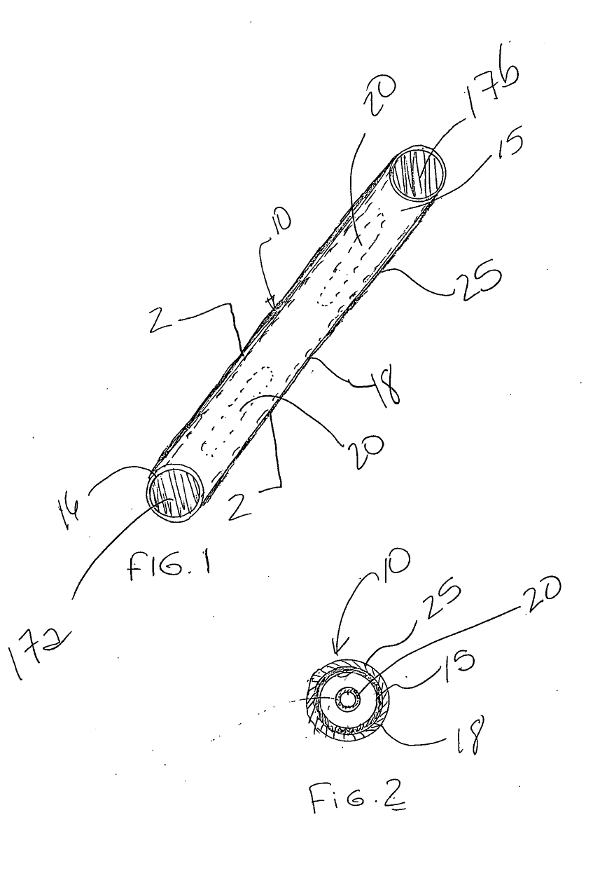

Turning now to the drawings, FIG. 1 illustrates an insect trapping device 10. Insect trap 10 includes a polymeric tube 15 formed of a flexible polymeric composition. Tube 15 has a first solution enclosed within the wall 16 of the tube 15. Each end 17a, 17b, is enclosed by welding of a polymeric seal, or cap or some such method. A second solution is enclosed within capsules 20. The tube 15 may be bent to break capsules 20, releasing the second solution. Upon mixing of the second solution and the first solution, fluorescence or phosphorescence occurs. The outer surface 18 of polymeric tube 15 has disposed thereon, a tacky adhesive coating 25. A radial cross-sectional view taken at section 2-2 in FIG. 1 is shown in FIG. 2.

Glow stick 10 in the embodiment described in FIGS. 1 and 2, is shown in the shape of an elongated cylinder. However, glow stick 10, may take on any geometric configuration including, but not limited to, rectangles, cylinders, discs, spheres, squares, triangles, rhombi, and so forth.

Outer surface of glow stick 10 has an adhesive composition such that when the insects fly to the glow stick 10, they become stuck to the adhesive composition on the outer surface.

In some embodiments, it may be necessary to etch or treat the surface of the polymeric material, or to provide a tie layer, prior to application of the sticky or tacky adhesive composition.

Glow stick 10, may further include a device for hanging the glow stick 10. For example, it may be desirable to hang glow stick 10 from a tree branch, beam, hanger, patio, deck rail, etc.

The present invention may use any of a variety of illumination or light sources including, but not limited to, chemical sources including fluorescent or phosphorescent compounds, incandescent lighting, fluorescent lighting, UV lighting, LEDs, etc.

Any chemiluminescent mixture may be employed herein and are known in the art. For example, see U.S. Pat. Nos. 5,772926; 4,184,193; 3,775,336; 3,749,679; 3,729,426; 3,597,362; each of which is incorporated by reference herein in its entirety.

Another useful compositions are described in U.S. Pat. No. 5,122,306, the entire content of which is incorporated by reference herein in its entirety. The compositions described therein include hydrogen peroxide with a perylene derivative fluorescer.

Another useful chemiluminescent composition is described in U.S. Pat. No. 4,508,642, the entire content of which is incorporated by reference herein. Ditridecyl phthalate and ditridecyl adipate are employed for increasing brightness and duration in chemiluminescent systems wherein a hydrogen peroxide component and an oxalate ester-fluorescer component are mixed and reacted to produce light.

Furthermore, chemiluminescent devices which are in the form of a cylindrical, transparent, and flexible container in the form of a stick, a pipe, a wire, a line or the like, are known. An ampule is provided in the hollow of the container and is hollow and breakable. Two liquid substances for chemiluminescence are contained in the hollows of the container and the ampule, respectively, and are capable of performing chemiluminescence when mixed with each other in the container. See for example, U.S. Pat. No. 5,321,587, the entire content of which is incorporated by reference herein.

In some embodiments, the present invention employs compounds which fluoresce phosphoresce wherein no battery source is required.

Any compounds capable of luminescence may be employed herein. One example of a chemiluminescent chemical reaction which may be employed to produce fluorescence is a solution of hydrogen peroxide and a solution containing a phenyl oxalate ester and a fluorescent dye. Other hydroperoxides or peroxides may also be employed herein. A catalyst may also be employed.

Any suitable solvents may be employed.

Hydrogen peroxide oxidizes phenyl oxalate ester, resulting in phenol and an unstable peroxyacid ester which further decomposes to a cyclic peroxy compound which decomposes to carbon dioxide releasing energy to the dye which excites the electrons in the dye. When the electrons fall back down to a lower energy state, they release energy in the form of light. Mixing of the two solutions starts the chemical reaction required to emit light.

A variety of fluorophors may be selected for use depending on the color which is desired. Some suitable fluorescent compounds for use in the present invention are those which have spectral emission falling between 300 and 1200 nanometers. Examples include, but are not limited to, the conjugated polycyclic aromatic compounds having at least 3 fused rings such as anthracene, substituted anthracene, benzanthracene, phenanthrene, substituted anthracene, benzanthracene, phenanthrene, substituted phenanthrene, naphthacene, substituted naphthacene, pentacene, substituted pentacene, perylene, substituted perylene, violanthrone, substituted violanthrone, and the like. Typical substituents for all of these are phenyl, lower alkyl (C₁-C₆), chloro, bromo, cyano, alkoxy (C₁-C₁₆), and other like substituents which do not interfere with the light-generating reaction contemplated herein.

Specific examples of fluorescers include, but are not limited to, 9,10-bis(phenylethynyl)anthracene; 1-methoxy-9,10-bis(phenylethynyl)anthracene; perylene, 1,5-dichloro 9,10-bis(phenylethynyl)anthracene; rubrene; monochloro and dichloro substituted 9,10-bis(phenylethynyl)anthracene; 5,12-bis(phenylethynyl)tetracene; 9,10-diphenyl anthracene; and 16,17-dihexyloxyviolanthrone; 9,10-diphenanthracene(blue); 9,10-bis(phenylethynyl)anthracene(green); 1-chloro-9,10-bis(phenylethynyl)anthracene; 9,10-Bis-(4-methoxyphenyl)-2 chloroanthracene; (RUBRENE®, yellow); 5,12-bis(phenylethynyl)-naphthacene (RHODAMINE® 6G, orange); (RHODAMINE® B, red); 5,16,11,12-tetraphenylnapthacene; LUMOGEN RED® (a red-emitting perylene dicarboximide fluorescer); LUMOGEN YELLOW® (a yellow emitting perylene dicarboximide fluorescer); LUMOGEN ORANGE® (an orange emitting perylene dicarboximide fluorescer); and so forth.

Dyes may also be employed. For example, the red fluorophors such as Rhodamine®& B are not typically employed in the oxalate esters. Fluorescent red pigment may be molded into the polymeric shell for encasing the glow stick chemicals. These pigments absorb light produced as a result of the chemiluminscent chemical reaction and re-emit is as red, or the color of the pigment selected for use in the polymeric shell.

Of course, the reactants are placed in suitable solvents for use in the present invention.

Insect traps employing such fluorescent compounds may last from about 4 to about 12 hours. Temperatures of about 15° C. to about 28° C. may be most suitable for use. High temperatures may result in more intense luminescence but for a shorter period of time.

Combinations of fluorophors or phosphorescent compounds may be employed herein. See U.S. Pat. No. 6,267,914 for a discussion of compounds useful in chemiluminescent reactions and combinations thereof, the entire content of which is incorporated by reference herein in its entirety.

Thus, chemical solutions such as those described above, require no power source.

Some forms of illumination such as LEDs and incandescent or fluorescent lighting, further require a power sources such as a battery. The present invention is designed for portability, however, thus, no AC power source or no plug-ins are necessary.

If a battery operated power source is employed, rechargeable batteries may be desirable for use.

The compositions employed on the outer surfaces to adhere insects may be formed from a sticky or tacky polymer composition. Suitably, the coating is a pressure sensitive adhesive which has tack sufficient to adhere insects, keeping them trapped on the surface of the device.

The coating may be solvent based, water based, or a hot melt composition.

The compositions according to the invention may include at least one polymer material. Suitable polymer materials include both elastomeric and non-elastomeric polymer materials.

Suitable classes of non-elastomeric materials include, but are not limited to, polyolefins including polyethylene and polypropylene, polyamides, polyurethanes, polyesters, polyethers, polyimides, acrylics, etc., as well as copolymers and terpolymers thereof. As used herein, copolymer shall hereinafter be employed to refer to any polymer material formed using more than one monomer.

Suitable classes of elastomeric materials include, but are not limited to, natural rubbers, block copolymers including styrenic block copolymers and polyamide block copolymers such as polyether-block-amides, polyurethanes, etc.

Preferred materials for use herein include the styrenic block copolymers. Examples of styrenic block copolymers include, but are not limited to, styrene-isoprene-styrene (SIS), styrene-butadiene-styrene (SBS), styrene-ethylene/butylene-styrene (SEBS), styrene-isobutylene-styrene (SIBS), styrene-ethylene/propylene-styrene (SEPS), as well as the diblock polymers including SI and SB, for example. A specific example are those styrenic block copolymers available under the tradename of KRATON® including KRATONS G, KRATON® D, etc.

In some embodiments, it may be desirable to employ hydrogenated, UV resistant polymers.

The compositions according to the invention may optionally include tackifying resins, oils, plasticizers, antioxidants, perfumes or scents, dyes, pigments, etc.

Gel-like substances such as mid to higher molecular weight polybutenes, may also be added to the compositions as well.

Examples of suitable tacking resins include both hydrogenated and non-hydrogenated forms and include, but are not limited to, gum rosins, aliphatic hydrocarbon resins, terpene based resins, terpene phenolic resins, rosin esters,

Examples of suitable synthetic polyterpene resins include, but are not limited to, those marketed under the tradename of WINGTACK® available from Goodyear Chemicals including the Wingtack® 95 resin, which is a synthetic polyterpene derived from C5 hydrocarbon resins, Wingtack® 115, and those available under the tradename of PICCOLYTE® from Hercules including A-100, A-115, A-125 and A-135 resins. Such resins are derived from the monomer alpha-pinene. Another commercially available terpene resin is available from Nevelle Chemical Company under the tradename of NEVPENE® 9500.

It may also be advantageous to employ mixtures of tackifying resins as well.

Addition of a tackifying resin or mixtures thereof not only provides quick tack to the adhesive composition, but also serves to lower the viscosity which is particularly advantageous when applying hot melt adhesives, which are 100% solids systems.

Furthermore, small amounts of waxes may be optionally employed. Waxes in too large of quantities may be detrimental to the tack. One of ordinary skill in the art has knowledge of the use of waxes in adhesive compositions.

The compositions may be applied to the outer surface of the insect traps according to the invention using any method known in the art. Examples include, but are not limited to, spraying, dipping, coating, painting, brushing, etc. The compositions may be applied in such a way that the entire surface of the insect trap is coated, or such that the outer surface of the trap is only partially coated. For example, spray applications may result in surfaces which do not have 100% coverage.

Any of the above processes such as dipping and spraying can be repeated if thicker coatings, or more surface coverage is desired.

In one embodiment, the coating is provided on a chemiluminescent device of the type described in U.S. Pat. No. 5,321,587, the entire content of which is incorporated by reference herein. See also U.S. Pat. Nos. 5,043,851; 4,193,109; 3,539,794; 4,814,949, each of which is incorporated by reference herein in its entirety, for other constructions.

Another useful construction is described in U.S. Pat. No. 5,158,349, the entire content of which is incorporated by reference herein in its entirety, wherein a multi-color chemical lighting device is described, the device having coextensive inner and outer tubes, wherein the inner tube contains multiple, segregated oxalate components, is described. Upon activation the device generates a distinct multi-color array of light.

Preferably, the compositions are substantially colorless and clear. Some adhesive compositions may naturally have more color than others, depending on the polymer system, tackifiers, oils, etc. which are employed.

In some embodiments, it may be suitable to employ opaque, or dyed or pigmented compositions as well.

It may be desirable to add perfumes to the compositions in order to make them more pleasing to the human olfactory system as well as making it more attractive to insects.

Furthermore, the present invention is available in a variety of colors. Some colors may be more preferable for use depending on the type of insect for which it is being employed. For example, fleas are known to prefer green.

The present invention offers the advantages of being safe and non-toxic, i.e. environmentally friendly, portable, disposable and/or reusable, power sources are not required, uses little or no energy, etc.

The present invention may be employed in any outdoor or indoor setting to attract annoying and pesky insects. The present invention finds particular utility for outdoor activities. For example, for use on decks, patios and porches, for camping, hunting, fishing, for picnicking, for use in motor homes, for use in garages and barns, etc.

The above disclosure is intended to be illustrative and not exhaustive. This description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. An insect trap comprising:
a luminescent source having an outer surface; and
an adhesive composition applied to the outer surface, for trapping insects.

2. The trap of claim 1 wherein said luminescent source is a fluorescent or phosphorescent compound or mixture of compounds.

3. The trap of claim 1 wherein said light source is incandescent.

4. The trap of claim 3 wherein said trap further comprises a power source in communication with said light source.

5. The trap of claim 4 wherein said power source is a battery.

6. The trap of claim 5 wherein said battery is rechargeable or disposable.

7. The trap of claim 1 further comprising a power source, the power source in communication with the light source.

8. The trap of claim 1 wherein said trap is in the form of a stick or cylinder.

9. The trap of claim 8 wherein said light source is fluorescent.

10. The trap of claim 1 wherein said light source is a liquid.

11. The trap of claim 1 wherein said adhesive is a pressure sensitive adhesive.

12. The trap of claim 11 wherein said adhesive comprises a styrenic block copolymer having styrene end blocks.

13. The trap of claim 12 wherein said styrenic block copolymer comprises a midblock selected from the group consisting of isoprene, butadiene, ethylene/propylene, ethylene/butylenes and isobutylene.

14. The trap of claim 11 wherein said adhesive comprises a diblock copolymer, a triblock copolymer or mixture thereof.

15. The trap of claim 1 further comprising a device for hanging said insect trap.

16. A glow stick formed from a polymeric shell having an outer surface and an inner surface, the glow stick comprising within the polymeric shell, a compound that glows, and the outer surface of said glue stick comprising a coating of material having sufficient tack to adhere insects.

17. The glow stick of claim 16 further comprising a release liner over said coating.

18. The glow stick of claim 16 in the shape of a rectangle, cylinder, disc, sphere, square, triangle or rhombus.

19. The glow stick of claim 16 in the shape of an elongated rectangle or elongated cylinder.

20. The glow stick of claim 16 wherein said coating is a pressure sensitive adhesive.
